(19) United States
(12) Patent Application Publication
(10) Pub. No.: US 2018/0091842 A1
(43) Pub. Date: Mar. 29, 2018

(54) APPARATUS AND METHOD FOR INFORMATION PROCESSING

(71) Applicant: FUJITSU LIMITED, Kawasaki-shi (JP)

(72) Inventor: YASUNORI KURODA, Tanba (JP)

(73) Assignee: FUJITSU LIMITED, Kawasaki-shi (JP)

(21) Appl. No.: 15/692,667

(22) Filed: Aug. 31, 2017

(30) Foreign Application Priority Data
Sep. 26, 2016 (JP) 2016-187237

(51) Int. Cl. H04N 21/41; H04N 21/43; H04N 21/433

(52) U.S. Cl. CPC H04N 21/4122; H04N 21/4126; H04N 21/47202; H04N 21/4333; H04N 21/4307

(57) ABSTRACT

An information processing apparatus includes a memory and a processor coupled to the memory. The processor configured to perform causing a display unit of an operation apparatus to display information for designating a playback target content, accepting the designation of the playback target content from the operation apparatus, based on an operation about the information for designating the content on the operation apparatus, and playing back the content with the designation being accepted by a playback output unit of the information processing apparatus.

### CROSS-REFERENCE TO RELATED APPLICATION

This application is based upon and claims the benefit of priority of the prior Japanese Patent Application No. 2016-187237, filed on Sep. 26, 2016, the entire contents of which are incorporated herein by reference.

### FIELD

The embodiments discussed herein are related to a apparatus for information processing and a method for information processing.

### BACKGROUND

In recent years, network environments have been enriched, and spreads of personal computers, tablet-type devices and other equivalent apparatuses (which will hereinafter be generically termed terminals) connected to the network environments have been accelerated owing to decreased costs.

For example, schools introduce inexpensive tablet-type devices for the terminals, in which individual learning for a student to individually learn is enriched. Other than the individual learning, there is a demand for a lesson style of an active learning method by which information is shared within a class or a group by displaying a terminal screen on a screen of a display device instanced by a monitor, a projector and a TV system (which will hereinafter be generically termed display devices). Thus, the school may possibly take three learning modes, i.e., the individual learning, simultaneous learning conducted by all the students within a class room and cooperative learning conducted by a group.

For conducting the simultaneous learning and the cooperative learning, e.g., such a mode of system is utilized that the terminal screen of a user is transferred to a presentation apparatus instanced by a personal computer and a server computer connected via a signal cable and an audio cable to the display device. To be specific, the terminal transfers image data on the screen to the presentation apparatus via an Access Point (AP) by using a Local Area Network (LAN) technology or a wireless LAN technology. In other words, the user copies and displays the screen of the terminal in an as-is status on the display device, whereby the simultaneous learning and the cooperative learning are conducted. Note that the same screen as the screen of the terminal is copied to and displayed in the as-is-status on the display device is also referred to as mirror display.

Activities at, other than the schools, a variety of places instanced by enterprises, research institutes, multiple corporate bodies, public offices and city halls have opportunities for displaying a screen of an information processing apparatus operated by the user on the display device. The activities at the enterprises involve playing back and outputting various types of media contents containing dynamic images, static images, sounds/voices, documents and materials without being limited to displaying on the display device.

### DOCUMENTS OF RELATED ARTS

### Patent Documents

[Patent Document 1] U.S. Pat. No. 8,918,822
[Patent Document 2] Web site of Google Inc., [online], “CHROMECAST LEARN HOW TO CAST ON YOUR TV”, [Searched on 23 Sep. 2016], Internet https://www.google.com/intl/en_us/chromecast/learn-tv/

### SUMMARY

According to an aspect of the embodiments, an information processing apparatus includes a memory and a processor coupled to the memory. The processor configured to perform causing a display unit of an operation apparatus to display information for designating a playback target content, accepting the designation of the playback target content from the operation apparatus, based on an operation about the information for designating the content on the operation apparatus, and playing back the content with the designation being accepted by a playback output unit of the information processing apparatus.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of an information system including a presentation apparatus and a terminal to operate the presentation apparatus;

FIG. 2 is a diagram illustrating processes in a comparative example;

FIG. 3 is a diagram illustrating a processing example in an embodiment 1;

FIG. 4 is a diagram illustrating a thumbnail screen;

FIG. 5 is a diagram illustrating a screen of a controller;

FIG. 6 is a diagram illustrating a relationship between commands and labels on the screen of the controller;

FIG. 7 is a diagram illustrating a hardware configuration of the terminal;

FIG. 8 is a diagram illustrating a hardware configuration of a presentation apparatus;

FIG. 9 is a flowchart, in which the terminal receives a dynamic HTML file from the presentation apparatus and displays thumbnails;

FIG. 10 is a flowchart, in which after the terminal has received a selection of content from the thumbnails displayed on the screen, the presentation apparatus displays the content on a display device, and a controller is displayed on the screen of the terminal;

FIG. 11 is a flowchart of display control of the presentation apparatus and a display process of the display device after the terminal has displayed the controller on the screen and received a selection of a button; and

FIG. 12 is a diagram illustrating an information processing apparatus according to the embodiment.

### DESCRIPTION OF EMBODIMENTS

However, following problems exist in the method of, as by the mirror display, displaying the screen of the terminal operated by the user in the as-is status on the display device. The user of the terminal desires to display the content existing in a file within the terminal on the display device. However, because of the method of displaying the terminal screen in the as-is status on the display device, items of information other than display target information, instanced by wall paper within the terminal screen, a shortcut screen and a screen for searching the file of the content within the terminal are displayed in the as-is status on the display device. In this case, the information other than the display target information may possibly contain items that are desirably invisible to viewers/audiences. In other words, the information other than the display target information has hitherto been displayed to the viewers/audiences including outsiders irrespective of privacy and security. The same with the problems described above is applied to a case of playing back the content containing an output of the sounds/voices without being limited to displaying the information. Herein, a process, which includes playing back a video, displaying an image, displaying a document and outputting sounds/voices, is called a playback output, and an apparatus for performing the playback output is to be termed an apparatus for the playback output.

It is an object of the present embodiments to play back a presentation target content to be presented to viewers/audiences by a specified apparatus for the playback output and, on the other hand, to output information other than the presentation target content, or an operation for preparing the playback of the presentation target content to only a display unit on the side of a user as a presenter.

A presentation apparatus according to one embodiment will hereinafter be described with reference to the drawings. A configuration of the following embodiment is an exemplification, and the present presentation apparatus is not limited to the configuration of the embodiment.

### Embodiment 1

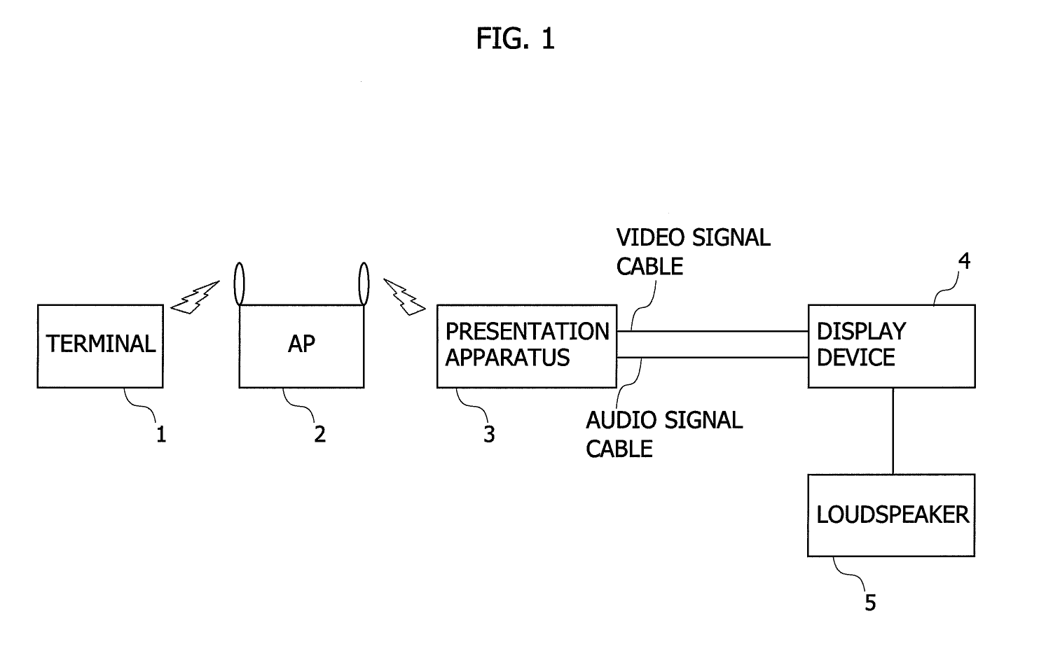

FIG. 1 illustrates a configuration of an information system including the presentation apparatus 3 according to the embodiment and a terminal 1 to operate the presentation apparatus 3. As in FIG. 1, the terminal 1 and the presentation apparatus 3 are connected by an access point (AP) 2, i.e., a wireless LAN. However, the terminal 1 and the presentation apparatus 3 may also be connected by a wired LAN. The terminal 1 is one example of an “operation apparatus”. The presentation apparatus 3 is one example of an “information processing apparatus”. The presentation apparatus 3 is also one example of a “computer”. In other words, the presentation apparatus 3 executes following processes in accordance with a program deployed in an executable manner on a main storage device instanced by a memory by way of one example of an information processing method.

The presentation apparatus 3 is connected to a display device 4 by a video signal cable and an audio signal cable. The display device 4 may be connected to a loudspeaker 5 and may also have the built-in loudspeaker 5. The loudspeaker 5 may also be connected directly to the presentation apparatus 3 by the audio signal cable without via the display device 4. The display device 4 is one example of a “playback output unit”. The loudspeaker 5 is also one example of the “playback output unit”.

In the embodiment, the presentation apparatus 3 is installed with a program operating as a WEB server. The presentation apparatus 3 runs application software for playing back a file of media content and other equivalent software (which will hereinafter be simply termed the contents) including teaching materials used when learning. Note that the contents according to the embodiment include, in addition to the teaching materials used at schools, videos that are played back or edited in a variety of scenes of society, static images, documents, materials, computer graphic data and other equivalent data, which are displayed or edited likewise.

The presentation apparatus 3 generates a dynamic HyperText Markup Language (HTML) file, which can be previewed on the terminal 1, and transmits the HTML file to the terminal 1. The presentation apparatus 3 runs a WEB server function by using a variety of processing systems in order to execute the processes described above. The processing systems used for the WEB server can be herein exemplified by Hypertext Preprocessor (PHP) and Practical Extraction and Report Language (Perl). It does not, however, mean that the processing system used by the presentation apparatus 3 is limited to PHP or Pearl as the configuration of the embodiment. The presentation apparatus 3 may also start up other programs from the WEB server by employing Common Gateway Interface (CGI).

The presentation apparatus 3 running the WEB server generates a dynamic HTML file within the presentation apparatus 3. For generating the dynamic HTML file, the presentation apparatus 3 acquires a list of files of contents and others within a designated folder on the presentation apparatus 3. It may be herein sufficient that the designated folder is set as, e.g., a system parameter of the presentation apparatus 3.

The presentation apparatus 3 embeds, into the dynamic HTML file, file IDs, thumbnail images and controller information for operating the applications associated with the files. Herein, the file ID specifies a file name, an extension or a file path. The thumbnail image is a simplified image representing a file of the content. The controller information is information for designating an individual controller that operates the application for playing back the content, and contains a graphic design and an operation instruction command of the controller.

The terminal 1, upon receiving the dynamic HTML file from the presentation apparatus 3, displays a web page linking to the dynamic HTML file in preview, thus enabling a user to check the web page. The terminal 1 accepts a selection of the thumbnail on the web page via a browser, and transmits an instruction of playing back the content associated with the thumbnail to the presentation apparatus 3. The terminal 1 displays the controller to accept a way of playing back the content via the browser, accepts a user's instruction, and transmits this instruction to the presentation apparatus 3.

For example, when selecting a certain thumbnail or a button (described by the HTML) of the controller, the terminal 1 runs a module (e.g., Java (registered trademark)) for performing asynchronous communications, and transmits a content ID, a shortcut key and other equivalent items to the presentation apparatus 3 through the asynchronous communications. A program to run, e.g., the WEB server may be compiled to operate the application within the presentation apparatus 3 by using Object Linking and Embedding (OLE) and the shortcut key upon receiving a selection command of the content and the instruction command of operating the application from the browser.

More specific processes of the terminal 1 and the presentation apparatus 3 are given as follows. For example, the terminal 1 starts up the browser in accordance with the user's operation, and accepts an input of “IP address+HTML file” of the presentation apparatus 3 in an “URL” field on a screen of the terminal 1. The terminal 1 accesses the presentation apparatus 3 via the wireless LAN through the browser.

The presentation apparatus 3 incorporates the list of files containing the contents within the designated folder into the dynamically generated HTML file, and transmits the dynamic HTML file to the terminal 1. The terminal 1 displays the web page in the dynamic HTML, and accepts the user's selection of the content from the list of thumbnails. To be specific, the browser of the terminal 1 analyzes attributes of the HTML file transmitted from the presentation apparatus 3, sorts analyzed items of data, thumbnailizes information for selecting the contents, and displays a list of thumbnails on the screen of the terminal 1.

The terminal 1, upon receiving the user's selection of, e.g., a content A, transmits a content ID and a playback instruction command (which will hereinafter be termed an OPEN command) of the selected content A to the WEB server by a script function of the browser. The terminal 1 selects a controller A incorporated into the dynamic HTML file from the ID of the selected content A, generates a graphic object of the controller, and displays this graphic object on the screen on the side of the terminal 1.

The presentation apparatus 3 running the WEB server receives, from the terminal 1, the content ID and the OPEN command of the content A selected by the terminal 1. The presentation apparatus 3 obtains a file path of the content A from the ID of the content A. The presentation apparatus 3 starts up, based on designation of the OPEN command, an application A for playing back the content A and initiates playing back the designated content A in a screen mode by using the OLE and the shortcut key. The presentation apparatus 3 instructs the display device 4 to display the content A, thereby displaying and playing back the content A in full screen on the screen of the display device 4. When the content A contains sounds/voices, the sounds/voices are outputted from the loudspeaker 5. As a result of the processes described above, It does not happen that the controller A on the side of the terminal 1 is visible to the display device 4.

For example, when the terminal 1 accepts a selection of a playback/pause instruction command (which will hereinafter be simply termed a Play/Pause command) by the operation button of the controller A, and transmits the Play/Pause command to the WEB server by the script function of the browser.

The presentation apparatus 3 running the WEB server receives the Play/Pause command from the terminal 1, and plays back or pauses the application A by using the shortcut key. For example, when the playback of a certain application A is underway, the presentation apparatus 3, upon receiving the Play/Pause command from the terminal 1, pauses the playback of the application A being currently played back by using the shortcut key, with the result that a display content on the display device 4 transitions to a pause screen from a playback screen. It does not therefore happen that the screen of the controller on the side of the terminal 1 is visible to the display device 4.

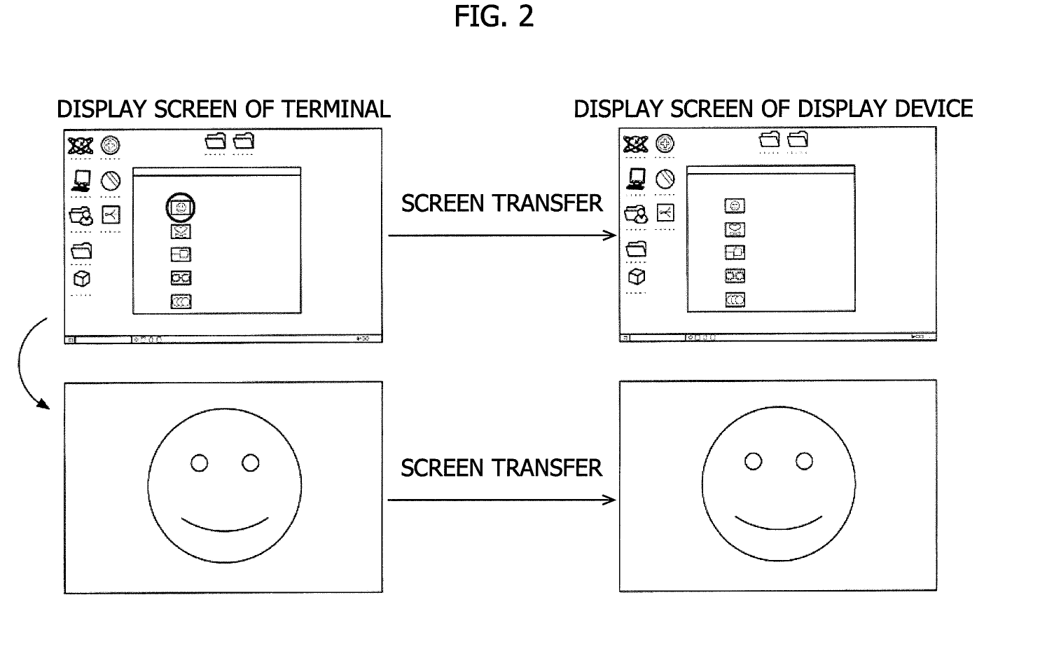

FIG. 2 illustrates processes in a comparative example. In the comparative example, the terminal 1 performs a screen transfer of the display content on the screen to the presentation apparatus 3, while the presentation apparatus 3 displays in an as-is status the screen of the terminal 1 receiving the screen transfer on the display device 4, and outputs the sounds/voices to the loudspeaker 5. In the comparative example, the terminal 1 transfers image data to the presentation apparatus 3 via the AP 2 by employing the wireless LAN. In other words, the display device 4 mirror-displays the screen, i.e., displays a copied screen of the terminal 1.

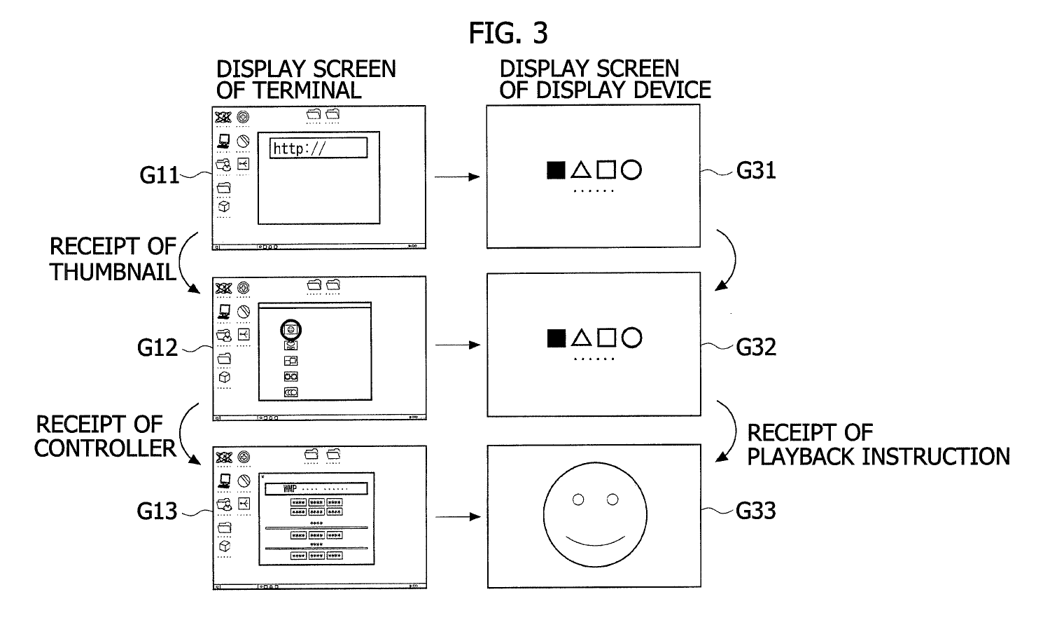

FIG. 3 illustrates a processing example according to the embodiment. In this example, at first, the terminal 1 accepts designation of Uniform Resource Locator (URL) for accessing the content stored in the presentation apparatus 3 (screen G11). The terminal 1 accesses the WEB server of the presentation apparatus 3. The WEB server of the presentation apparatus 3 incorporates the thumbnail specifying the content into the dynamic HTML file, and distributes the dynamic HTML file to the terminal 1. The terminal 1 displays a page based on the distributed dynamic HTML file (screen G12). Hereat, any change does not occur on the screen of the display device 4 connected to the presentation apparatus 3 (screens G31, G32).

The terminal 1 accepts an operation of selecting the thumbnail from the user, and instructs the presentation apparatus 3 to play back the content associated with the selected thumbnail. The presentation apparatus 3 starts up the application for playing back the instructed content, and outputs the content to the display device 4 or the loudspeaker 5 (screen G33). Note that the presentation apparatus 3 previously distributes a page of the controller for controlling the playback of the content to the terminal 1 in a way that contains the page in the dynamic HTML file.

The terminal 1 displays, on the screen, the controller associated with the content selected from the thumbnails (screen G13). Hereafter, the terminal 1 accepts the user's operation with respect to the controller, and transmits a command associated with the button on the controller to the presentation apparatus 3. The presentation apparatus 3 controls the playback of the content in accordance with the transmitted command.

The HTML file to be distributed to the terminal 1 and files of the contents A, B, C . . . exist within the presentation apparatus 3. In the procedure described above, the terminal 1 receives the distribution of the HTML file from the presentation apparatus 3, and displays the web page by the browser. On the other hand, the presentation apparatus 3 outputs the contents A, B, C . . . in accordance with the application started by the presentation apparatus 3 without displaying the HTML file on the display device 4. In other words, the display device 4 displays only the content associated with the application started up by the presentation apparatus 3.

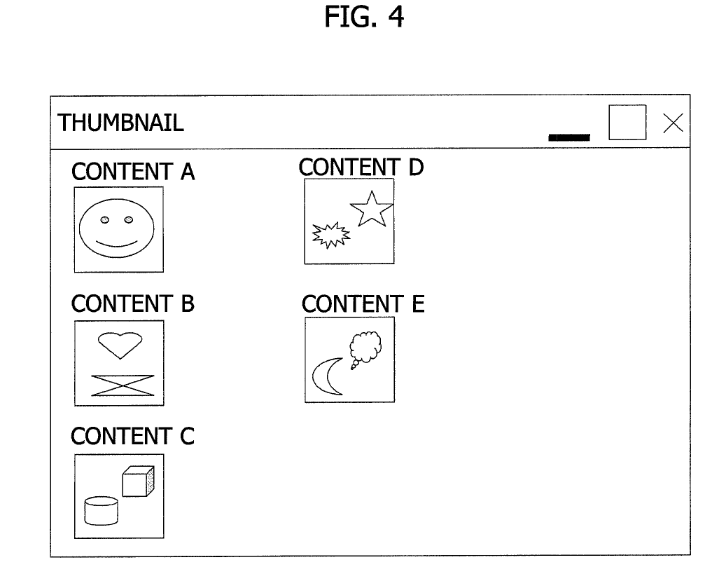

FIG. 4 illustrates a thumbnail screen. As described above, the thumbnail screen is a web page screen generated by the presentation apparatus 3 and described by the dynamic HTML. Displayed on the thumbnail screen is a list of thumbnails associated with the contents A, B, C, D, E and so on each stored in a predetermined folder of the presentation apparatus 3.

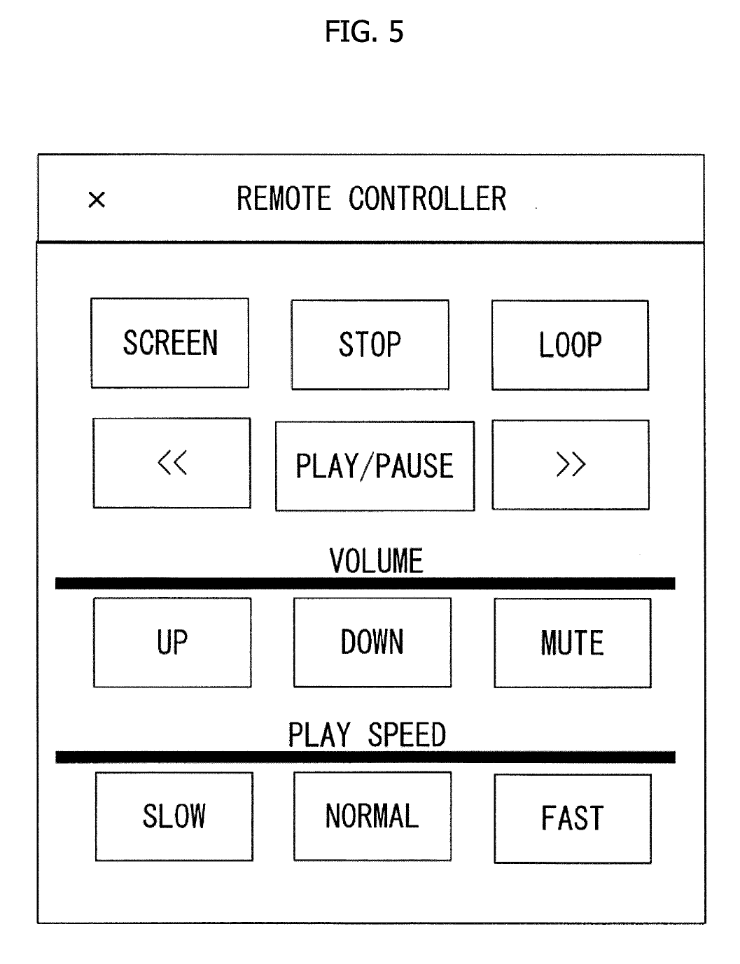

FIG. 5 illustrates a controller screen. The controller in FIG. 5 is a controller that controls a video player program for playing back a video file. The controller is not, however, limited to the controller that controls the video player program but may include various types of controllers. Exemplified are controllers corresponding to an audio player program for playing back the sounds/voices, a TV program for receiving a TV broadcast, a reader program for displaying a document file, an editor program for editing a document, and other equivalent programs.

In the example of FIG. 5, the controller, which controls the video player program, includes a button (marked with “X”) for closing the screen, screen operation buttons, i.e., SCREEN, STOP, LOOP, <<, >> and PLAY/PAUSE, volume adjusting buttons, i.e., UP, DOWN and MUTE, and playback speed adjusting buttons, i.e., SLOW, NORMAL and FAST. The terminal 1, upon detection of operating the button on the controller, transmits a command associated with the button with its operation being detected to the presentation apparatus 3.

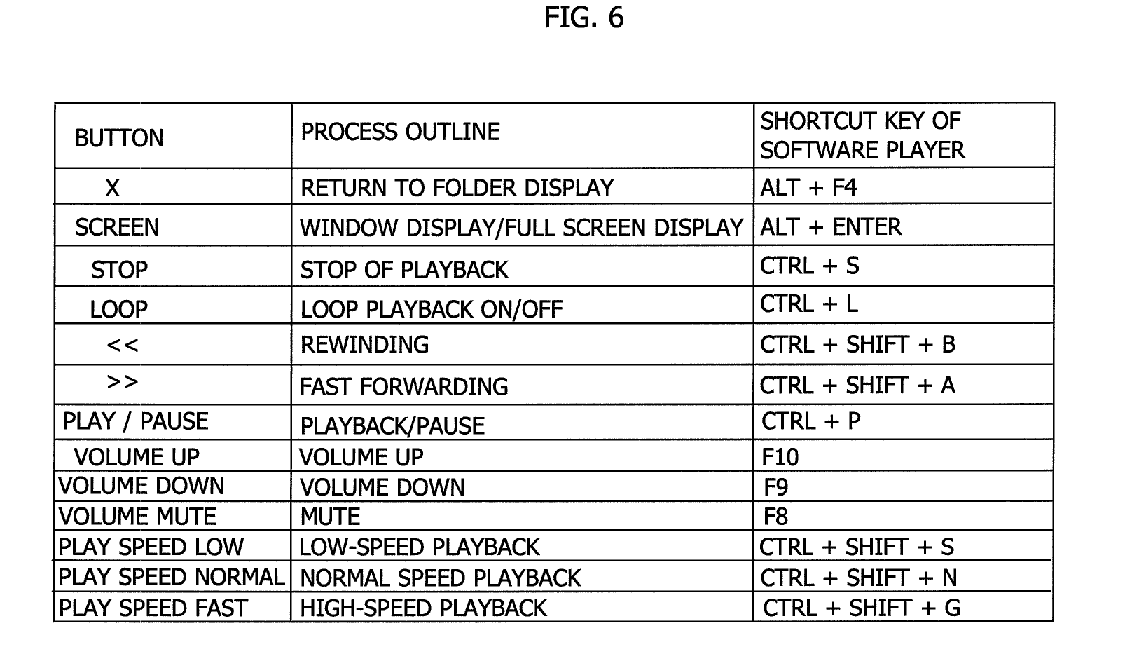

FIG. 6 illustrates a relationship between commands and labels on the screen of the controller. For example, a function of the button (marked with “X”) for designating that the controller is closed is “return to folder display”. When this button is pressed, the terminal 1 running the controller transmits a command for designating the shortcut key “ALT+F4” to the control target presentation apparatus 3. Herein, the shortcut key “ALT+F4” signifies an indication of pressing an ALT button and an F4 button simultaneously. Hereinafter the same will apply.

A function of the SCREEN button is a switchover of “window display/full-screen display”. Upon pressing this button, a command for designating a shortcut key “ALT+ENTER” is transmitted.

Defined similarly are STOP, LOOP, <<, >>, PLAY/PAUSE, UP and DOWN of VOLUME, MUTE, and SLOW, NORMAL and FAST of PLAY SPEED.

These buttons designate a stop of playback, a switchover of ON/OFF of loop playback, rewinding, fast forwarding, a switchover of playback/stop, up and down of volume, mute, a low-speed playback, a normal speed and a high-speed playback. Commands associated with “CTRL+S”, “CTRL+L”, “CTRL+SHIFT+B”, “CTRL+SHIFT+A”, “CTRL+P”, “F10”, “F9”, “F8”, “CTRL+5”, “CTRL+N”, and “CTRL+G” are transmitted by pressing these buttons.

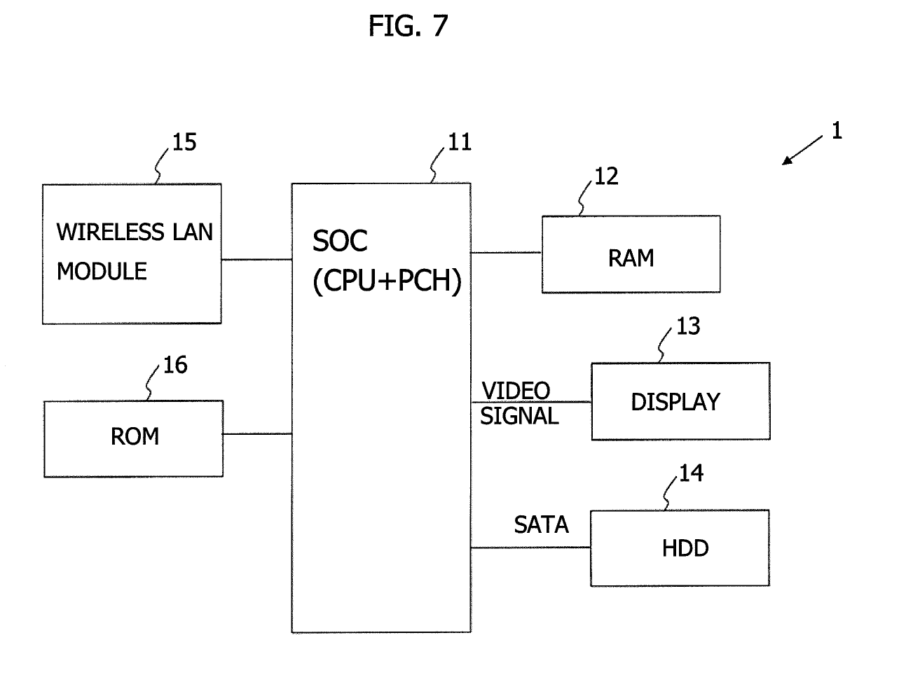

FIG. 7 illustrates a diagram of a hardware configuration of the terminal 1. As in FIG. 7, the terminal 1 includes a System-on-a-chip (SOC) 11, a Random Access Memory (RAM) 12, a display 13, a Hard Disk Drive (HDD) 14, a wireless LAN module 15, and a Read Only Memory (ROM) 16.

The SOC 11 includes a Central Processing Unit (CPU) and a Platform Controller Hub (PCH). The SOC 11 has a CPU circuit and peripheral circuits, which are packaged on a chip. The SOC 11 is defined as a semiconductor chip designed by a design technique of implementing functions for operations of the system on one semiconductor chip. It does not, however, mean that the terminal 1 according to the embodiment is limited to the terminal including the SOC 11. The CPU may also take a multi-cpu configuration and a multicore configuration without being limited to the single CPU.

The RAM 12, which is called a main storage device, stores a computer program to be run by the SOC 11 or data to be processed by the SOC 11. The display 13 displays, to the user, information corresponding to a process by the SOC 11 in accordance with a video signal transmitted from the SOC 11. The display 13 is one example of a “display unit” of an operation apparatus. The HDD 14 drives a hard disk to store the computer program to be run by the SOC 11 or the data to be processed by the SOC 11. The hard disk is also called an external storage device. The HDD 14 is connected to the SOC 11 via an interface based on standards of, e.g., Serial Advanced Technology Attachment (Serial ATA (SATA)). Note that a Solid State Drive (SSD) may also be used in place of the HDD 14.

The wireless LAN module 15 accesses a wireless LAN network, and executes processing as a communication interface of the SOC 11. The ROM 16 stores, e.g., firmware, i.e., the firmware to be run by the SOC 11 and also system parameters and other equivalent data. For example, a Serial Peripheral Interface (SPI) ROM is used as the ROM 16.

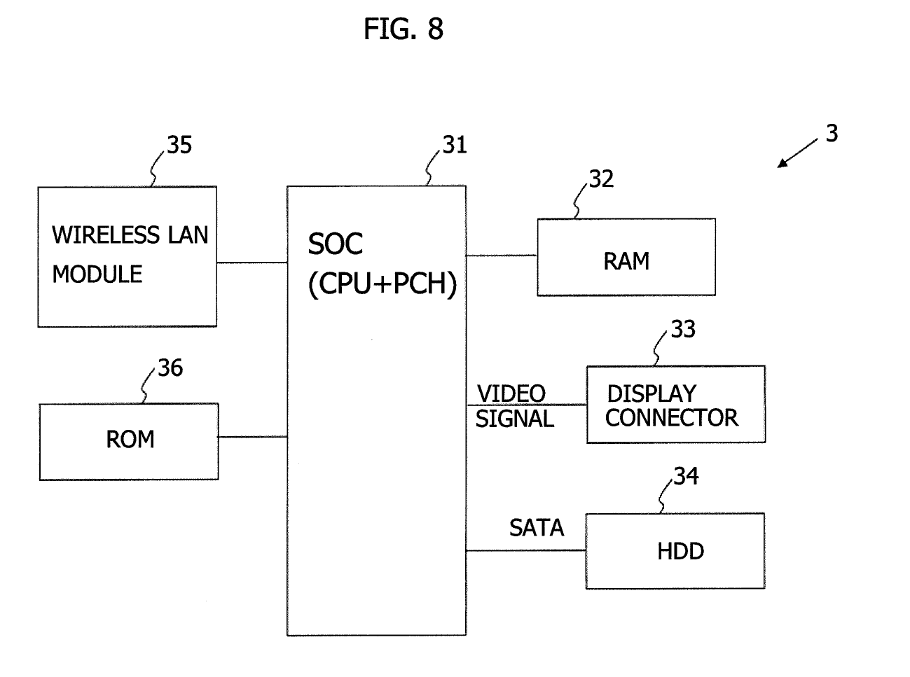

FIG. 8 illustrates a diagram of a hardware configuration of the presentation apparatus 3. The presentation apparatus 3 includes a SOC 31, a RAM 32, a display connector 33, a HDD 34, a wireless LAN module 35, and a ROM 36. The SOC 31, the RAM 32, the HDD 34, the wireless LAN module 35 and the ROM 36 are the same as the SOC 11, the RAM 12, the HDD 14, the wireless LAN module 15 and the ROM 16 in FIG. 7. The presentation apparatus 3 is connected to the display device 4 and the loudspeaker 5 in FIG. 1 via the display connector 33.

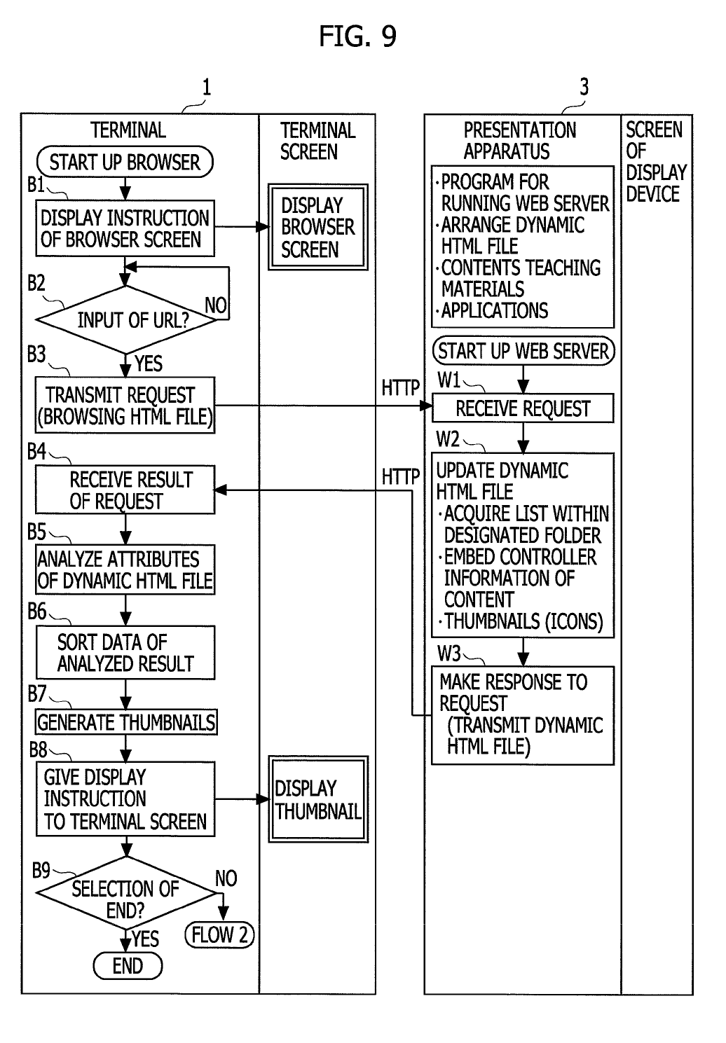

FIG. 9 illustrates a flowchart (referred to as Flow 1), in which the terminal 1 receives the dynamic HTML file from the presentation apparatus 3 and displays the thumbnails. Herein, the presentation apparatus 3, which is installed with the program for running the WEB server function, generates and distributes the dynamic HTML file. The presentation apparatus 3 previously stores the application and other equivalent software for playing back the files of the contents.

In this process, the terminal 1 accepts an instruction of displaying the browser screen, based on the user's operation (B1), and displays the browser screen. The terminal 1 waits for a URL to be inputted (B2). When the user inputs the URL for accessing the presentation apparatus 3 (Y in B2), the terminal 1 transmits a Hypertext Transfer Protocol (HTTP) request, i.e., an HTML browsing request to the presentation apparatus 3 (B3).

The presentation apparatus 3 receives the request from the terminal 1 because of running the WEB server (W1). The process in W1 is one example of a process that “accepting a request for acquiring information for designating the playback target content from the operation apparatus”. The presentation apparatus 3 updates the dynamic HTML file (W2). For example, the presentation apparatus 3 acquires the list of files of the contents within the designated folder. The presentation apparatus 3 embeds the content ID, the controller information, the thumbnail images and other equivalent items into the dynamic HTML file. The presentation apparatus 3 sends back the dynamic HTML file in response to the request given from the terminal 1 (W3). The process in S3 is one example of a process that “causing a display unit of an operation apparatus to display information for designating a playback target content”. The process in W3 is also one example of a process that “transmitting a response containing the information for designating the playback target content to the operation apparatus in response to the acquisition request”. The thumbnail is one example of the “information for designating the playback target content”. The content is one example of the “playback target content”.

The terminal 1 receives the dynamic HTML file as a result of the request (B4). The terminal 1 analyzes attributes, e.g., a tag structure or definitions of tags of the dynamic HTML file (B5). The terminal 1 sorts data of an analyzed result of the dynamic HTML file (B6). More specifically, the terminal 1 builds up the screen by generating computer graphics components from the analyzed result. The terminal 1 generates the thumbnails (B7). The terminal 1 instructs the terminal screen to displays the thumbnails (B8), thereby the thumbnails are displayed. The terminal 1 accepts a selection about whether the processing is finished (B9). The terminal 1, when not finishing the processing, advances the processing to Flow 2.

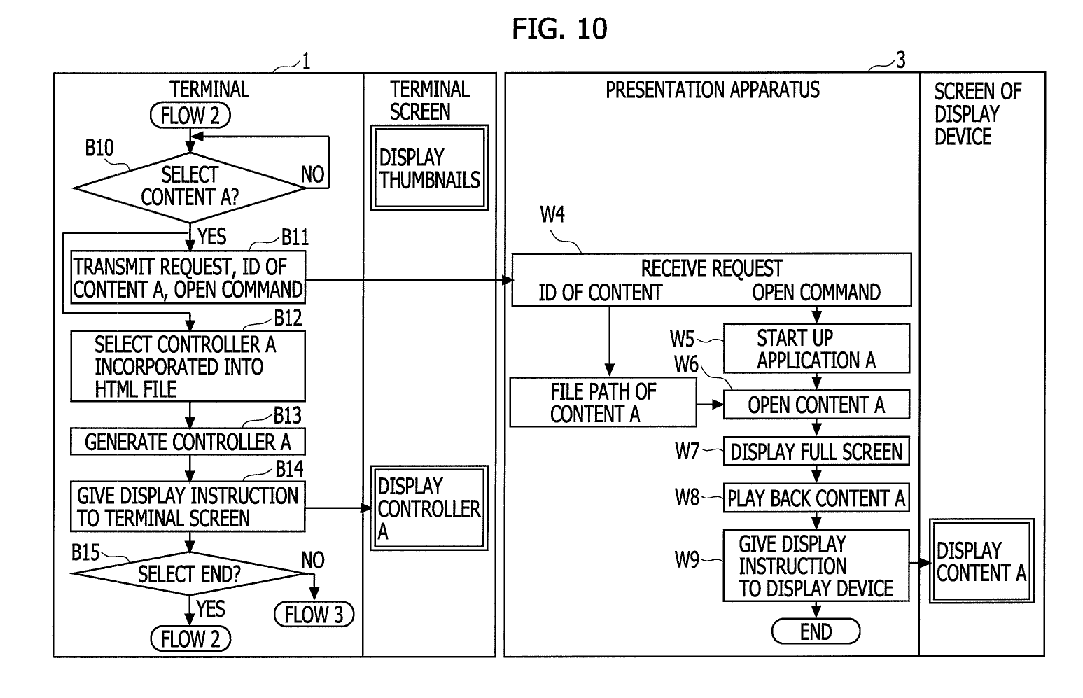

FIG. 10 illustrates a flow (referred to as Flow 2), in which after the terminal 1 has received the selection of the content A from the thumbnails displayed on the screen, the presentation apparatus 3 displays the content A on the display device 4, and the controller A is thereby displayed on the screen of the terminal 1. In this process, the terminal 1 waits till the user selects the content (B10). The terminal 1, when accepting the user's selection of the content (e.g., the content A) (Y in B10), transmits a request to the presentation apparatus 3 through the asynchronous communications (B11). Herein, the request is defined as a command (which is termed the OPEN command in the embodiment) for playing back playing back the content A specified by the content ID.

The terminal 1 selects the controller A (the controller associated with the content A) built in the HTML file in parallel with transmitting the request (B12). The terminal 1 generates the controller A on the screen of the terminal 1 (B13). The terminal 1 instructs the terminal screen to display the controller A on the screen of the terminal 1 (B14). The terminal 1 accepts the selection as to whether the processing is finished (B15). The terminal, when the processing is not finished, advances the processing to Flow 3.

On the other hand, the presentation apparatus 3, upon receiving the request from the terminal 1 (W4), starts up the application A (the application for playing back the content A) in accordance with the OPEN command in the request (W5). The process in W4 is one example of a process that “accepting the designation of the playback target content from the operation apparatus, based on an operation about the information for designating the content on the operation apparatus”. The process in W5 is one example of a process that “the control unit starting up a computer program (W5) used for a playback output unit to play back the content with the designation being accepted”.

The presentation apparatus 3 opens the file of the content A designated by a file path of the content A included in the request (W6). The presentation apparatus 3 displays a window in full screen on the display device 4 (W7). The presentation apparatus 3 plays back the content A in the window displayed in full screen on the display device (S8). The presentation apparatus 3 instructs the display device 4 to display the content A (W9). The display device 4 displays the content A. Note that the loudspeaker 5 may also be set to output the sounds/voices, depending on the content A. The processes in S8 and W9 are one example of “playing back the content with the designation being accepted by a playback output unit of an information processing apparatus”. The display device 4 is one example of an “output device”. The loudspeaker 5 is also one example of the “output device”.

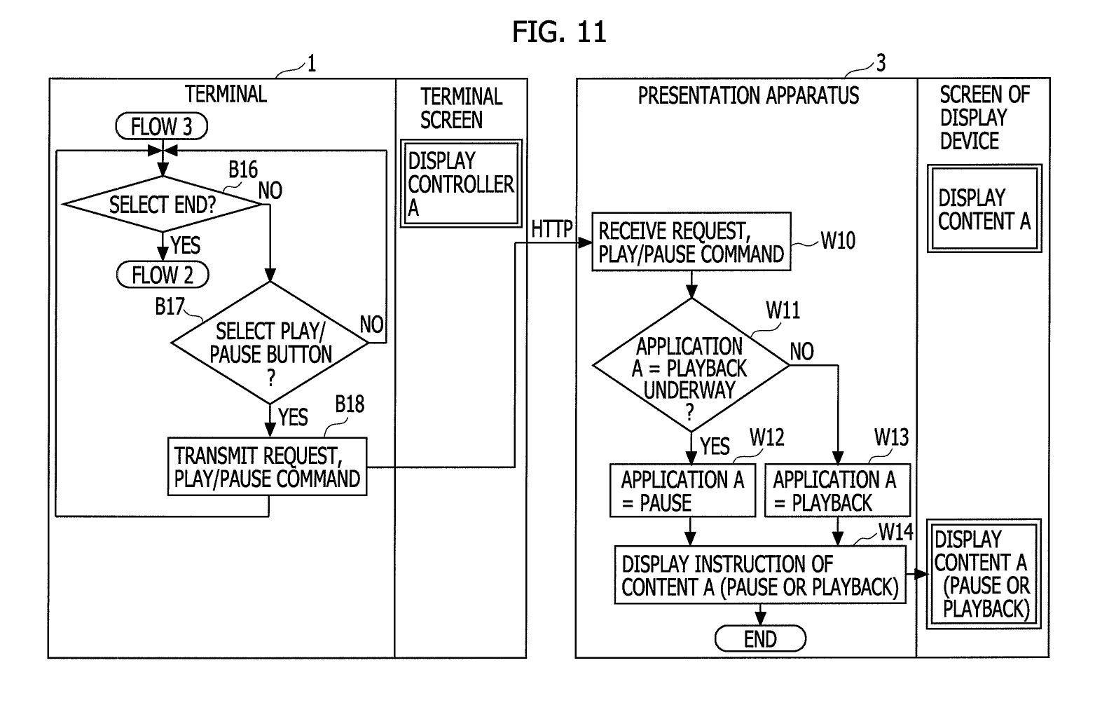

FIG. 11 illustrates control of the presentation apparatus 3 and a display processing flow (referred to as Flow 3) of the display device 4 after the terminal 1 has displayed the controller A and after receiving a selection of a Play/Pause button. In this process, the terminal 1 determines whether the user selects an end (B16). When the user selects the end (Y in B16), the terminal 1 returns the processing to Flow 2. Whereas when the user does not select the end, the terminal 1 determines whether the user selects any of buttons. In the example of FIG. 11, the terminal 1 determines whether the Play/Pause button is selected (B17). When the Play/Pause button is selected, the terminal 1 transmits the Play/Pause command as the request through the asynchronous communications (B18). Thereafter, the terminal 1 loops back the processing to B16. Note that FIG. 11 illustrates the process of selecting the Play/Pause button, but the controller A can accept other buttons.

The presentation apparatus 3 receives the request through the asynchronous communications (W10). Herein, the request is defined as, e.g., Play/Pause command. The presentation apparatus 3 determines whether the playback of the application A is underway (W11). When the playback of the application A is underway, the presentation apparatus 3 makes setting to pause the playback of the application A (W12). Whereas when the playback of the application A is not underway, the presentation apparatus 3 makes setting to play back the application A (W13). The presentation apparatus 3 sends, based on the setting, an instruction of displaying the application A to the display device 4 (W14). The display device 4 displays the content A in a pause or playback status.

As described above, the presentation apparatus 3 according to the embodiment operates as the WEB server when playing back the file of the content, and, at first, transmits the dynamic HTML file to the terminal 1. The presentation apparatus 3, upon receiving the playback instruction (OPEN command) through the asynchronous communications from the terminal 1, plays back and outputs the file of the content to the display device 4 and the loudspeaker 5. The playback instruction (OPEN command) is generated when selecting the thumbnail associated with the file of the content on the terminal 1, and is transmitted as the request through the asynchronous communications to the presentation apparatus 3. Accordingly, a playback result of the file of the content by the presentation apparatus 3 is outputted to the display device 4, but the user's operation and the information on the screen of the terminal 1 are outputted to only the screen of the terminal 1 without being outputted to the display device 4. As a result, the user plays back the file of the content, in which case the file can be played back without displaying unnecessary items of information on the display device 4. Accordingly, when the user plays back the file of the content on the occasion of presentation in a lesson at a school or at a conference, the unnecessary items of information can be set invisible to viewers/audiences.

In the embodiment, the presentation apparatus 3, upon receiving the request from the terminal 1, acquires the list of files of the contents from the designated folder, and embeds the content IDs, the controller information and the thumbnail images into the dynamic HTML file. The presentation apparatus 3 sends back the dynamic HTML file in response to the request given from the terminal 1. Accordingly, the presentation apparatus 3 updates the list of files of the contents by the dynamic HTML whenever receiving the request from the terminal 1, and is thereby enabled to present the updated list to the terminal 1. The embodiment involves using the dynamic HTML, and the terminal 1 and the presentation apparatus 3 are thereby enabled to use the existing computer program for performing the HTTP-based communications. For example, it may be sufficient that the presentation apparatus 3 runs the WEB server, while the terminal 1 runs the browser.

In the embodiment, the presentation apparatus 3, when instructed to play back the file of the content, starts up the program associated with this file, thereby playing back the file. The presentation apparatus 3 does not therefore include a user interface related to the playback of the file of the content. Hence, the presentation apparatus 3 installs the program associated with each file, sets the IDs associated with the contents and the controller information in the dynamic HTML file according to the process of the WEB server, and is thereby enabled to flexibly support the playback of a file of a new content.

### Embodiment 2

The embodiment 1 has exemplified the information system configured to set the unnecessary items of information invisible to the viewers/audiences by the terminal 1 and the presentation apparatus 3 so that the operation on the terminal 1 or the screen of the terminal 1 is not displayed on the display device 4. It does not, however, mean that the processes in the embodiment 1 are limited to the information system having the configuration described above. For example, the terminal 1 and the presentation apparatus 3 may operate as virtual machines respectively on one physical machine. The physical machine is one example of a “computer”.

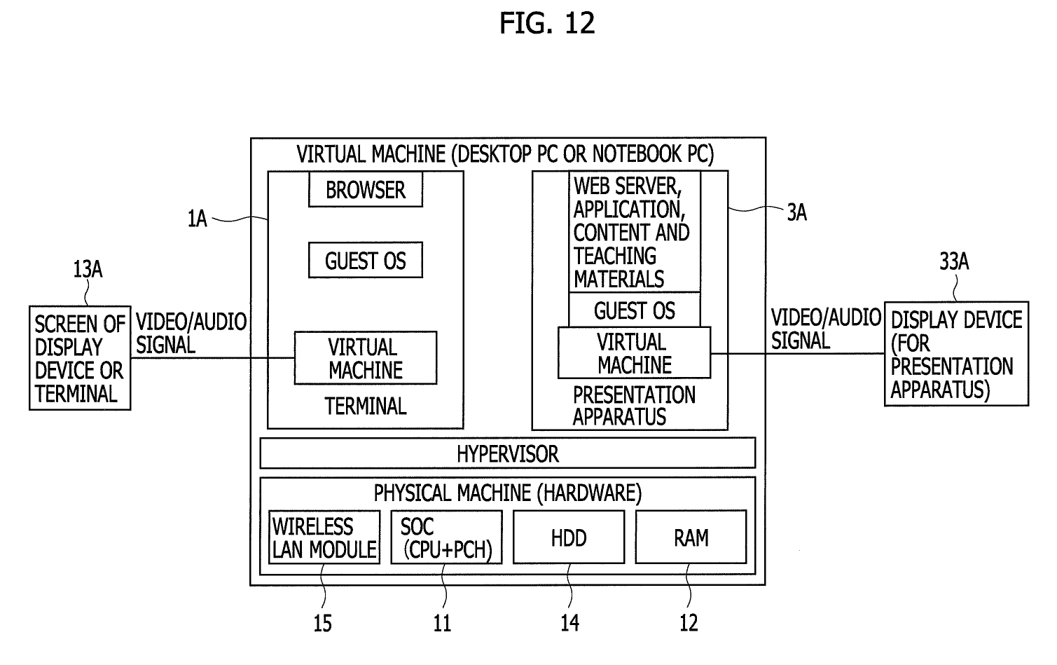

FIG. 12 illustrates an information processing apparatus according to an embodiment 2. The information processing apparatus according to the embodiment 2 includes the SOC 11, the RAM 12, the HDD 14 and the wireless LAN module 15 as the physical machine. A configuration of the physical machine in FIG. 12 is the same as, e.g., the terminal 1 in FIG. 7 or the presentation apparatus 3 in FIG. 8. A virtualization program instanced by Hypervisor runs on the physical machine. The virtualization program configures a virtual machine by virtualizing a configuration of the physical machine, and runs a guest OS on each virtual machine. Herein, the terminal 1 is configured as the virtual machine, and the browser runs on the guest OS. A presentation apparatus 3A is configured as another virtual machine, and stores the WEB server program, the application for playing back the files of the contents, and these files.

A display device (or a screen of the terminal) 13A is connected to a virtual I/O of the virtual machine of a terminal 1A. A display device 33A is connected to the virtual I/O of the virtual machine of the presentation apparatus 3A. Accordingly, the browser in the embodiment 1 runs on the terminal 1A operating as the virtual machine, and the WEB server in the embodiment 1 runs on the presentation apparatus 3A operating as the virtual machine. Thus, in an environment of one physical machine, it is feasible to play back only the file of the content without displaying the operation and the screen of the terminal 1A on the display device 33A. In this case, the operation and the screen of the terminal 1A are displayed on the display device 13A.

The presentation apparatus 3A is one example of the “information processing apparatus operating as a first virtual machine virtualized by a virtualization program on a physical machine”. The display device 33A is one example of the “playback output unit being controlled in playback of the content by the information processing apparatus operating as the first virtual machine”. The terminal 1A is one example of a “terminal operating as a second virtual machine virtualized by the virtualization program on the physical machine”. The display device (or the screen of the terminal) 13A is one example of a “display unit being made to display information for designating the playback target content by the operation apparatus operating as the second virtual machine”.

With this configuration, the file of the content can be played back in the same way as in the embodiment 1 by building up the environment in FIG. 12 on, e.g., a notebook PC, a tablet-type device, a Personal Digital Assistant (PDA) and other equivalent apparatuses, and combining one computer with the desktop display device 33A. Accordingly, when the user makes a presentation at the conference, an academic meeting and the lesson at the school, in which members of the public participate, the presentation can be made by setting the unnecessary items of information invisible to the viewers/audiences.

### <<Non-Transitory Computer Readable Recording Medium>>

A program making a computer, other machines and apparatuses (which will hereinafter be referred to as the computer and other equivalent apparatuses) attain any one of the functions, can be recorded on a non-transitory recording medium readable by the computer and other equivalent apparatuses. The computer and other equivalent apparatuses are made to read and run the program on this non-transitory recording medium, whereby the function thereof can be provided.

Herein, the non-transitory recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses. Among these non-transitory recording mediums, the mediums removable from the computer and other equivalent apparatuses are exemplified by a flexible disc, a magneto-optic disc, a CD-ROM, a CD-R/W, a DVD, a Blu-ray disc, a DAT, an 8 mm tape, and a memory card like a flash memory. A hard disc, a Read-Only Memory (ROM) and other equivalent recording mediums are given as the non-transitory recording mediums fixed within the computer and other equivalent apparatuses. Further, a Solid State Drive (SSD) is also available as the non-transitory recording medium removable from the computer and other equivalent apparatuses and also as the non-transitory recording medium fixed within the computer and other equivalent apparatuses.

According to the information processing apparatus, it is feasible to play back the presentation target content to be presented to the viewers/audiences by the specified apparatus for the playback output and, on the other hand, to output the information other than the presentation target content, or the operation for preparing the playback of the presentation target content to only the display unit on the side of the user as the presenter.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus, comprising:
a memory; and
a processor coupled to the memory and the processor configured to perform:
causing a display unit of an operation apparatus to display information for designating a playback target content;
accepting the designation of the playback target content from the operation apparatus, based on an operation about the information for designating the content on the operation apparatus; and
playing back the content with the designation being accepted by a playback output unit of the information processing apparatus.

2. The information processing apparatus according to claim 1, wherein the processor further configured to perform:
accepting a request for acquiring information for designating the playback target content from the operation apparatus; and
transmitting a response containing the information for designating the playback target content to the operation apparatus in response to the acquisition request.

3. The information processing apparatus according to claim 1, wherein the processor further configured to perform starting up a computer program used for a playback output unit to play back the content with the designation being accepted.

4. The information processing apparatus according to claim 1, wherein the information processing apparatus operates as a first virtual machine virtualized by a virtualization program on a physical machine,
the playback output unit is controlled in playback of the content by the information processing apparatus operating as the first virtual machine,
the operation apparatus operates as a second virtual machine virtualized by the virtualization program on the physical machine, and
the display unit is made to display information for designating the playback target content by the operation apparatus operating as the second virtual machine.

5. An information processing method, comprising:
causing a display unit of an operation apparatus to display information for designating a playback target content;
accepting the designation of the playback target content from the operation apparatus, based on an operation about the information for designating the content on the operation apparatus; and
playing back the content with the designation being accepted by a playback output unit of the information processing apparatus.

6. A non-transitory computer-readable recording medium having stored therein a program of an information processing apparatus including a processor, the program to cause the processor to perform:
causing a display unit of an operation apparatus to display information for designating a playback target content;
accepting the designation of the playback target content from the operation apparatus, based on an operation about the information for designating the content on the operation apparatus; and
playing back the content with the designation being accepted by a playback output unit of the information processing apparatus.
